(19) United States
(12) Patent Application Publication
(10) Pub. No.: US 2026/0127258 A1
(43) Pub. Date: May 7, 2026

(54) ACCESS CONTROL SYSTEM AND METHOD THEREOF

(71) Applicant: FAR EASTONE TELECOMMUNICATIONS CO., LTD., Taipei City (TW)

(72) Inventors: Chun-Chieh KUO, New Taipei City (TW); Ming-Shyan WANG, Taipei City (TW); Shui-Shu HSIAO, Taipei City (TW); Chien-Nan LEE, Taipei City (TW); Hua-Pei CHIANG, Taipei City (TW); Chyi-Dar JANG, Taipei City (TW); Tsung-Jen WANG, Taipei City (TW); Che-Yu LIAO, Taipei City (TW)

(21) Appl. No.: 19/081,199

(22) Filed: Mar. 17, 2025

(30) Foreign Application Priority Data
Nov. 7, 2024 (TW) 113142811

(51) Int. Cl. G06F 21/32; G06F 21/35; G06Q 10/0631; G07C 9/00

(52) U.S. Cl. CPC G06F 21/32; G06F 21/35; G06Q 10/06311; G07C 9/00182

(57) ABSTRACT

An access control system including an electronic lock, a storage unit, a proximity card reader and a control unit is provided. The storage unit stores a shift schedule including multiple scheduled personnel data. The proximity card reader reads a proximity card to obtain personnel information. When the proximity card reader reads the proximity card, the control unit obtains one of the scheduled personnel data from the storage unit according to the personnel information, and the control unit determines whether the current time matches the time slot field corresponding to the one of the scheduled personnel data. When the control unit determines that the current time matches the time slot field corresponding to the one of the scheduled personnel data, the control unit unlocks the electronic lock. Furthermore, an access control method is also provided.

### BACKGROUND OF THE INVENTION

This application claims priority for the TW application No. 113142811 filed on 7 Nov. 2024, the content of which is incorporated by reference in its entirely.

### FIELD OF THE INVENTION

The invention relates to a control system and method thereof, in particular, to an access control system and method thereof.

### DESCRIPTION OF THE PRIOR ART

For the purposes of safety, epidemic prevention and hierarchical management, it is quite common to set up controlled areas in enterprises, hospitals, public institutions and other places. Generally speaking, access control in controlled areas is performed by issuing a proximity card to the user, and allowing the user to control the opening and closing of the gate or door by placing the proximity card close to the reader for authentication when entering or exiting.

However, special drugs in current hospitals are often managed and distributed manually, which leads to problems in management. Therefore, relying solely on the proximity card for authentication cannot be effective in management. In order to help hospitals effectively establish intelligent drug management, the first thing to do is to strengthen the access control system to control the authority of drug recipients and provide a multiple verification mechanism so that the entire delivery process can be effectively checked and recorded. In this way, the safety and accuracy in management of collection and delivery for special drugs can be improved, and the collection and delivery time can be shortened, thereby improving control efficiency and quality in drug management.

### SUMMARY OF THE INVENTION

The invention provides an access control system and method thereof, which may provide dual authentication of proximity cards and shift schedules, thereby improving control efficiency and quality in management.

The invention provides an access control system including an electronic lock, a storage unit, a proximity card reader and a control unit. The storage unit stores a shift schedule including a plurality of scheduled personnel data, each of the scheduled personnel data including a scheduled personnel field and a time slot field. The proximity card reader reads any one of a plurality of proximity cards to obtain a personnel information, each of the personnel information corresponding to one of plurality of scheduled personnel data. The control unit is connected to the electronic lock, the storage unit and the proximity card reader. When the proximity card reader reads one of the proximity cards, the control unit obtains one of the scheduled personnel data from the storage unit according to the personnel information, and the control unit determines whether the current time matches the time slot field corresponding to the one of the scheduled personnel data. When the control unit determines that the current time matches the time slot field corresponding to the one of the scheduled personnel data, the control unit unlocks the electronic lock.

In an embodiment of the invention, the access control system further includes a mobile network module, which is connected to the control unit. When the control unit determines that the current time matches the time slot field corresponding to the one of the scheduled personnel data, the control unit receives an authentication information from the mobile network module so that the control unit unlocks the electronic lock according to the authentication information.

In an embodiment of the invention, the access control system further includes a sound receiving unit and an artificial intelligence voice recognition module. The sound receiving unit is connected to the control unit, the control unit receiving a voice signal via the sound receiving unit. The artificial intelligence voice recognition module is connected to the control unit via the mobile network module. The control unit transmits the voice signal to the artificial intelligence voice recognition module, and the artificial intelligence voice recognition module recognizes the voice signal as the authentication information.

In an embodiment of the invention, each of the scheduled personnel data further includes a password field. When the control unit receives the authentication information from the mobile network module, the control unit determines whether the authentication information matches the password field corresponding to the one of the scheduled personnel data. When the control unit determines that the authentication information matches the password field corresponding to the one of the scheduled personnel data, the control unit unlocks the electronic lock.

In an embodiment of the invention, the artificial intelligence voice recognition module includes a voiceprint feature extraction unit and a voiceprint feature matching unit. The voiceprint feature extraction unit extracts at least one voiceprint feature of the voice signal. The voiceprint feature matching unit matches the at least one voiceprint feature with the plurality of scheduled personnel data to generate the authentication information.

The invention further provides an access control method, which includes steps of: storing, by the storage unit, a shift schedule including a plurality of scheduled personnel data, each of the scheduled personnel data including a scheduled personnel field and a time slot field; reading, by a proximity card reader, any one of a plurality of proximity cards to obtain a personnel information, each of the personnel information corresponding to one of plurality of scheduled personnel data; obtaining, by a control unit, one of the plurality of scheduled personnel data from the storage unit according to the personnel information when the proximity card reader reads one of the plurality of proximity cards; determining, the control unit, whether a current time matches the time slot field corresponding to the one of the scheduled personnel data; and unlocking, by the control unit, an electronic lock when the control unit determines that the current time matches the time slot field corresponding to the one of the scheduled personnel data.

In an embodiment of the invention, the method, before the unlocking the electronic lock, further includes steps of: receiving, by the control unit, an authentication information from a mobile network module to determine whether to unlock the electronic lock according to the authentication information.

In an embodiment of the invention, the method, before the receiving, by the control unit, an authentication information, further includes steps of: receiving, by the control unit, a voice signal via a sound receiving unit; transmitting, by the control unit, the voice signal to an artificial intelligence voice recognition module; recognizing, by the artificial intelligence voice recognition module, the voice signal as the authentication information; and transmitting, by the artificial intelligence voice recognition module, the authentication information to the control unit via the mobile network module.

In an embodiment of the invention, each of the scheduled personnel data further includes a password field. Before the step of unlocking, by the control unit, the electronic lock, the access control method further includes steps of: determining, by the control unit, whether the authentication information matches the password field corresponding to the one of the scheduled personnel data; When the control unit determines that the authentication information matches the password field corresponding to the one of the scheduled personnel data, the control unit unlocks the electronic lock.

In an embodiment of the invention, the step of recognizing, by the artificial intelligence voice recognition module, the voice signal as the authentication information includes steps of: extracting, by a voiceprint feature extraction unit, at least one voiceprint feature of the voice signal; and matching, by a voiceprint feature matching unit, the at least one voiceprint feature with the plurality of scheduled personnel data to generate the authentication information.

Based on the above description, for the access control system and method thereof according to the above embodiments, dual authentication of proximity cards and shift scheduling is adopted, and short-term time period authority control is adopted, wherein it is necessary to check whether the shift schedule of specific personnel is consistent, and the authority is not a long-term authority. Therefore, the authority control of access control can be effectively strengthened, thereby improving efficiency and quality in management.

The following detailed description is made through specific embodiments in conjunction with the attached drawings, so that the purpose, technical content, characteristics and effects achieved by the invention can be more easily understood.

### BRIEF DESCRIPTION OF THE DRA WINGS

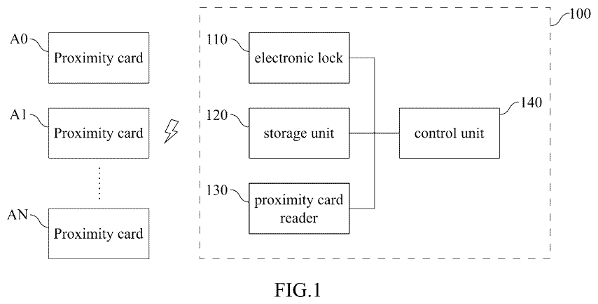

FIG. 1 is a block diagram of an access control system according to an embodiment of the invention;

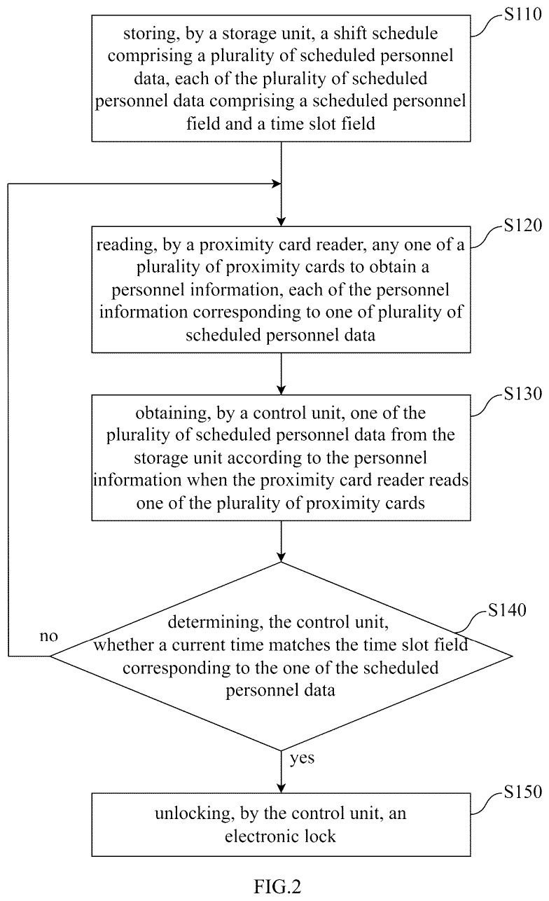

FIG. 2 is a flow chart of an access control method according to an embodiment of the invention;

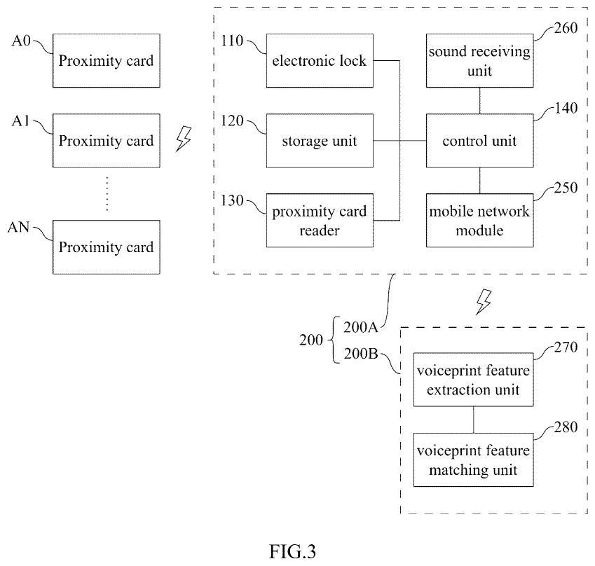

FIG. 3 is a block diagram of an access control system according to another embodiment of the invention; and

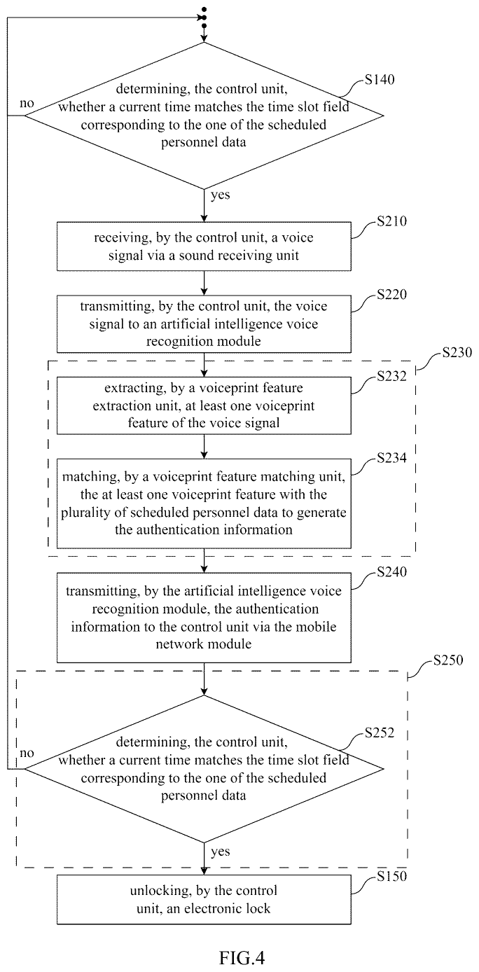

FIG. 4 is a flow chart of an access control method according to an embodiment of the invention.

### DESCRIPTION OF THE PREFERRED EMBODIMENTS

FIG. 1 is a block diagram of an access control system according to an embodiment of the invention. With reference to FIG. 1, the access control system 100 includes an electronic lock 110, a storage unit 120, a proximity card reader 130 and a control unit 140. There may be multiple electronic locks 110, which may be installed in different controlled drug areas of the hospital, graded controlled medicine cabinets, or other places that need to be controlled, but the invention is not limited thereto. The storage unit 120 stores a shift schedule. The shift schedule includes a plurality of scheduled personnel data, each of the scheduled personnel data including a scheduled personnel field and a time slot field. The storage unit 120 is, for example, any type of fixed or removable random access memory (RAM), read-only memory (ROM), flash memory, hard disk or other similar devices, integrated circuits or combinations thereof. The proximity card reader 130 reads any one of a plurality of proximity cards A0, A1˜AN to obtain a personnel information. Each of the personnel information corresponds to one of plurality of scheduled personnel data. The proximity card reader 130 may be a radio frequency identification (RFID) reader or a near field communication (NFC) reader, and the proximity card may have an embedded RFID tag or an NFC tag, but is not limited thereto.

The control unit 140 is connected to the electronic lock 110, the storage unit 120 and the proximity card reader 130. In the embodiment, the control unit 130 is, for example, a microcontroller, a field programmable gate array (FPGA), a central processing unit (CPU), an application specific integrated circuit (ASIC), or other similar devices, integrated circuits, or a combination thereof. When the proximity card reader 130 reads one of the proximity cards, the control unit 140 obtains one of the scheduled personnel data from the storage unit according to the personnel information, and the control unit 140 determines whether the current time matches the time slot field corresponding to the one of the scheduled personnel data. The control unit unlocks the electronic lock 110 when the control unit 140 determines that the current time matches the time slot field corresponding to the one of the scheduled personnel data.

FIG. 2 is a flow chart of an access control method according to an embodiment of the invention. With simultaneous reference to FIGS. 1 and 2, for the convenience of explanation, the access control method of FIG. 2 will be described below in conjunction with the access control system 100, but the invention is not limited thereto. First, step S110 is performed: the storage unit 120 stores a shift schedule including a plurality of scheduled personnel data, each of the scheduled personnel data including a scheduled personnel field and a time slot field. In the embodiment, the shift schedule may further be added with an authority field to achieve a hierarchical management effect by giving different authorities to different scheduled personnel. Next, step S120 is performed: the proximity card reader 130 reads any one of the proximity cards to obtain a personnel information, each of the personnel information corresponding to one of plurality of scheduled personnel data. In other words, when one of the scheduled personnel needs to take controlled drugs, he or she may use the distributed proximity card to approach the proximity card reader 130 for induction. Then, step S130 is performed: the control unit 140 obtains one of the plurality of scheduled personnel data from the storage unit according to the personnel information when the proximity card reader 130 reads one of the plurality of proximity cards. Then, step S140 is performed: the control unit 140 determines whether a current time matches the time slot field corresponding to the one of the scheduled personnel data.

And then, step S150 is performed: the control unit unlocks the electronic lock 110 when the control unit 140 determines that the current time matches the time slot field corresponding to the one of the scheduled personnel data. At this time, the scheduled personnel who have passed the dual authentication of the proximity card and the time slot may obtain the required controlled drugs. In contrast, if the step S140 determines that the current time does not match the time slot field corresponding to one of the scheduled personnel data, the scheduled personnel who have not passed the dual authentication are denied access to controlled drugs. In other words, the above embodiment adopts short-term time period authority control, and it is necessary to check whether the shift schedule of a specific person is consistent, and the authority is not a long-term authority. Therefore, even if the scheduled personnel have a proximity card with the required authority, they will not be able to access controlled drugs if they do not scan the proximity card during the corresponding time slot. It is worth mentioning that the dual authentication of proximity cards and scheduling time may improve the safety and accuracy in management of collection and delivery for special drugs, shorten the collection and delivery time, and thus improve efficiency and quality in drug management.

FIG. 3 is a block diagram of an access control system according to another embodiment of the invention. With reference to FIGS. 1 and 3, compared with the access control system 100, an access control system 200 may further includes a mobile network module 250, a sound receiving unit 260 and an artificial intelligence voice recognition module 200B. In the embodiment, the access control system 200 may be divided into an electronic lock device 200A and the artificial intelligence voice recognition module 200B. The structure of the electronic lock device 200A is similar to that of the access control system 100, and similar components are not described again. The electronic lock device 200A may be remotely connected to the artificial intelligence voice recognition module 200B via the mobile network module 250. The mobile network module 250 is connected to the control unit 140. When the control unit 140 determines that the current time matches the time slot field corresponding to the one of the scheduled personnel data, the control unit 140 receives an authentication information from the mobile network module 250) to determine whether to unlock the electronic lock 110 according to the authentication information. Since the 5G mobile network has the advantages of wide coverage and high network speed, the mobile network module 250 of the embodiment may adopt a 5G mobile communication module to complete the authentication and verification in a very short time.

The sound receiving unit 260 is connected to the control unit 140, the control unit 140 receiving a voice signal via the sound receiving unit 260. The artificial intelligence voice recognition module 200B is connected to the control unit 140 via the mobile network module 250. The control unit 140 transmits the voice signal to the artificial intelligence voice recognition module 200B, and the artificial intelligence voice recognition module 200B recognizes the voice signal as the authentication information. In the embodiment, the artificial intelligence voice recognition module 200B may include a voiceprint feature extraction unit 270 and a voiceprint feature matching unit 280. The voiceprint feature extraction unit 270 extracts at least one voiceprint feature of the voice signal. The voiceprint feature matching unit 280 matches the at least one voiceprint feature with the plurality of scheduled personnel data to generate the authentication information. The artificial intelligence voice recognition module 200B may be implemented by a processing device (not shown) in conjunction with software or other network equipment, server and other hardware, and using an existing known artificial intelligence voiceprint recognition model, which is not limited here. Further, in the shift schedule stored by the storage unit 120, each of the scheduled personnel data may further include a password field. The control unit 140 may determine whether the authentication information matches the password field corresponding to the one of the scheduled personnel data. The control unit 140 determines to unlock the electronic lock 110 when the control unit 140 determines that the authentication information matches the password field corresponding to the one of the scheduled personnel data. Further, in an embodiment not shown, the sound receiving unit 260 may record and mark the voice sample of a specific person, and then the voiceprint feature extraction unit 270 may extract the features of the voice sample of the specific person. The processing device establishes an artificial intelligence voiceprint recognition model for a specific speaker, and establishes a model for the password language question and answer corpus and natural language processing of the specific person.

FIG. 4 is a flow chart of an access control method according to an embodiment of the invention. The access control method of FIG. 4 is similar to some steps of the access control method of FIG. 2, and similar steps will not be repeated. Compared with the access control method of FIG. 2, between the step S140 and the step S150, the access control method of FIG. 4 further includes steps S210-S250. With simultaneous reference to FIGS. 3 and 4, for the convenience of explanation, the access control method of FIG. 4 will be described below in conjunction with the access control system 200, but the invention is not limited thereto. In addition to the dual authentication of the proximity card and the time slot revealed in FIG. 2, the access control method in FIG. 4 also has artificial intelligence authentication of voice signals. After the step S140, first the step S210 is performed, i.e., the control unit 140 receives the voice signal via the sound receiving unit 260. Next, the step S220 is performed: the control unit 140 transmits the voice signal to an artificial intelligence voice recognition module 200B. Then the step S230 is performed: the artificial intelligence voice recognition module 200B recognizes the voice signal as the authentication information. In the embodiment, the step S230 includes the following steps. First, a step S232 is performed: the voiceprint feature extraction unit 270 extracts at least one voiceprint feature of the voice signal. Next, a step S234 is performed: the voiceprint feature matching unit 280 matches the at least one voiceprint feature with the plurality of scheduled personnel data to generate the authentication information.

After the step S230, a step S240 is performed: the artificial intelligence voice recognition module 200B transmits the authentication information to the control unit 140 via the mobile network module 250. Subsequently, a step S250 is performed: the control unit 140 receives the authentication information from the mobile network module 250 to determine whether to unlock the electronic lock according to the authentication information. In the embodiment, the step S250 includes a step S252, i.e., the control unit 140 determines whether the authentication information matches the password field corresponding to the one of the scheduled personnel data. When the control unit 140 determines that the authentication information matches the password field corresponding to the one of the scheduled personnel data, the step S150 is performed, i.e., the control unit unlocks the electronic lock. It is worth mentioning that the embodiment uses artificial intelligence voiceprint recognition technology and natural language random password questions and answers to identify specific people, which can prevent identity fraud. Although the authentication information in the above embodiment is described by taking voice signals as an example, in another embodiment not shown, the authentication information may also be text messages such as SMS or phone number identity authentication information. For example, a display device (not shown) may be used to display a dynamic two-dimensional barcode, which can then be scanned by the scheduled personnel. After the scheduled personnel scans the two-dimensional barcode, the mobile network module 250 sends a text message or interacts with the scheduled personnel in real-time communication to generate the authentication information.

Based on the above description, for the access control system and method thereof according to the above embodiments, dual authentication of proximity cards and shift scheduling is adopted, and short-term time period authority control is adopted, wherein it is necessary to check whether the shift schedule of specific personnel is consistent, and the authority is not a long-term authority. Therefore, the authority control of drug control can be effectively strengthened, thereby improving efficiency and quality in drug management.

The embodiments described above are only for illustrating the technical ideas and features of the invention, and their purpose is to enable those skilled in the art to understand the contents of the invention and implement them accordingly. They cannot be used to limit the patent scope of the invention, i.e., all equivalent changes or modifications made according to the spirit disclosed by the invention should still be included in the patent scope of the invention.

What is claimed is:

1. An access control system, comprising:
an electronic lock;
a storage unit, storing a shift schedule comprising a plurality of scheduled personnel data, each of the plurality of scheduled personnel data comprising a scheduled personnel field and a time slot field;
a proximity card reader, reading any one of a plurality of proximity cards to obtain a personnel information, each of the personnel information corresponding to one of plurality of scheduled personnel data; and
a control unit, connected to the electronic lock, the storage unit and the proximity card reader,
wherein when the proximity card reader reads one of the plurality of proximity cards, the control unit obtains one of the plurality of scheduled personnel data from the storage unit according to the personnel information, and the control unit determines whether a current time matches the time slot field corresponding to the one of the scheduled personnel data;
when the control unit determines that the current time matches the time slot field corresponding to the one of the scheduled personnel data, the control unit unlocks the electronic lock.

2. The access control system according to claim 1, further comprising:
a mobile network module, connected to the control unit, wherein when the control unit determines that the current time matches the time slot field corresponding to the one of the scheduled personnel data, the control unit receives an authentication information from the mobile network module to determine whether to unlock the electronic lock according to the authentication information.

3. The access control system according to claim 2, further comprising:
a sound receiving unit, connected to the control unit, the control unit receiving a voice signal via the sound receiving unit; and
an artificial intelligence voice recognition module, connected to the control unit via the mobile network module, the control unit transmitting the voice signal to the artificial intelligence voice recognition module, the artificial intelligence voice recognition module recognizing the voice signal as the authentication information.

4. The access control system according to claim 3, wherein each of the plurality of scheduled personnel data further comprises a password field; when the control unit receives the authentication information from the mobile network module, the control unit determines whether the authentication information matches the password field corresponding to the one of the scheduled personnel data; when the control unit determines that the authentication information matches the password field corresponding to the one of the scheduled personnel data, the control unit unlocks the electronic lock.

5. The access control system according to claim 3, wherein the artificial intelligence voice recognition module comprises:
a voiceprint feature extraction unit, extracting at least one voiceprint feature of the voice signal; and
a voiceprint feature matching unit, matching the at least one voiceprint feature with the plurality of scheduled personnel data to generate the authentication information.

6. An access control method, comprising:
storing, by a storage unit, a shift schedule comprising a plurality of scheduled personnel data, each of the plurality of scheduled personnel data comprising a scheduled personnel field and a time slot field;
reading, by a proximity card reader, any one of a plurality of proximity cards to obtain a personnel information, each of the personnel information corresponding to one of plurality of scheduled personnel data;
obtaining, by a control unit, one of the plurality of scheduled personnel data from the storage unit according to the personnel information when the proximity card reader reads one of the plurality of proximity cards;
determining, the control unit, whether a current time matches the time slot field corresponding to the one of the scheduled personnel data; and
unlocking, by the control unit, an electronic lock when the control unit determines that the current time matches the time slot field corresponding to the one of the scheduled personnel data.

7. The access control method according to claim 6, before the unlocking the electronic lock, further comprising:
receiving, by the control unit, an authentication information from a mobile network module so that the control unit unlocks the electronic lock according to the authentication information.

8. The access control method according to claim 7, before the receiving, by the control unit, an authentication information, further comprising:
receiving, by the control unit, a voice signal via a sound receiving unit;
transmitting, by the control unit, the voice signal to an artificial intelligence voice recognition module;
recognizing, by the artificial intelligence voice recognition module, the voice signal as the authentication information; and
transmitting, by the artificial intelligence voice recognition module, the authentication information to the control unit via the mobile network module.

9. The access control method according to claim 7, wherein each of the plurality of scheduled personnel data further comprises a password field, and before the unlocking, by the control unit, the electronic lock, the access control method further comprises:
determining, by the control unit, whether the authentication information matches the password field corresponding to the one of the scheduled personnel data, and unlocking, by the control unit, the electronic lock when the control unit determines that the authentication information matches the password field corresponding to the one of the scheduled personnel data.

10. The access control method according to claim 8, wherein the step of recognizing, by the artificial intelligence voice recognition module, the voice signal as the authentication information comprises:
extracting, by a voiceprint feature extraction unit, at least one voiceprint feature of the voice signal; and
matching, by a voiceprint feature matching unit, the at least one voiceprint feature with the plurality of scheduled personnel data to generate the authentication information.
